(19) United States
(12) Patent Application Publication
(10) Pub. No.: US 2005/0145088 A1
(43) Pub. Date: Jul. 7, 2005

(54) Automated chime

(76) Inventor: Tung Hoi Tse, Wanchai (HK)

Correspondence Address: LEYDIG VOIT & MAYER, LTD, 700 THIRTEENTH ST. NW, SUITE 300, WASHINGTON, DC, 20005-3960, US

(21) Appl. No.: 10/751,636

(22) Filed: Jan. 6, 2004

(51) Int. Cl. G10F 1/08

(52) U.S. Cl. 84/103

(57) ABSTRACT

A chime apparatus includes a rose and a number of chime rods. A striker is attached to the rose and is positioned adjacent the chime rods. A motor activates the striker to strike the chime rods. The motor can be operated by a control circuit to move the striker to thereby simulate random chiming sounds.

### BACKGROUND OF THE INVENTION

The present invention relates to chimes. More particularly, although not exclusively, the invention relates to an indoor chime having a motor-driven pendulum,

Known wind chimes have a top part or “rose” from which a number of chime rods depend, usually in a circular array. At the centre of the array of chime rods and suspended from the rose by a cord is a pendulum or “striker”. Suspended beneath the pendulum, usually on the same cord, there is a paddle. When wind blows, the paddle catches the wind and moves the cord to thereby cause the pendulum to strike the chime rods. If there is insufficient wind, the chimes don't sound. Consequently, conventional wind chimes are generally ineffective indoors.

### OBJECT OF THE INVENTION

It is an object of the present invention to overcome or substantially ameliorate the above disadvantage and/or more Generally to provide an improved chime.

It is a further object of the present invention to provide a motor-driven chime useful in low wind situations.

### DISCLOSURE OF THE INVENTION

There is disclosed herein a chime apparatus comprising;
a rose,
a plurality of chime rods attached to the rose,
a striker attached to the rose and positioned adjacent the chime rods, and
a motor, which upon activation causes movement of the striker to strike the chime rods.

Preferably, the chime rods are suspended from the rose.

Preferably the striker is a pendulum suspended from the motor by a cord.

Preferably the pendulum is of a shape having corners.

Preferably the pendulum is triangular.

Preferably the cord extends between an output shaft of the motor and the pendulum.

Preferably a weight is attached to the cord beneath the pendulum.

Preferably a frame supports the rose and a base supports the frame.

Preferably a basket for receiving potpourri or the like is provided in or upon the base.

Preferably a fan is mounted in the base and is directed at the basket to thereby diffuse aroma from any substance located in said basket.

Preferably the apparatus includes a cap upon the rose and within which there is situated a light emitter such as a globe.

Preferably the cap is light transmissive.

Preferably the cap is coloured.

Preferably the apparatus further includes control means affecting operation of the motor.

Preferably said operation is periodic.

Preferably said operation includes reversal of the motor.

Additionally and/or alternatively, said operation includes random alterations of the direction and/or speed of the motor.

### BRIEF DESCRIPTION OF THE DRAWINGS

A preferred form of the present invention will now be described by way of example with reference to the accompanying drawings, wherein:

FIG. 1 is a schematic elevational view of a wind chime, and

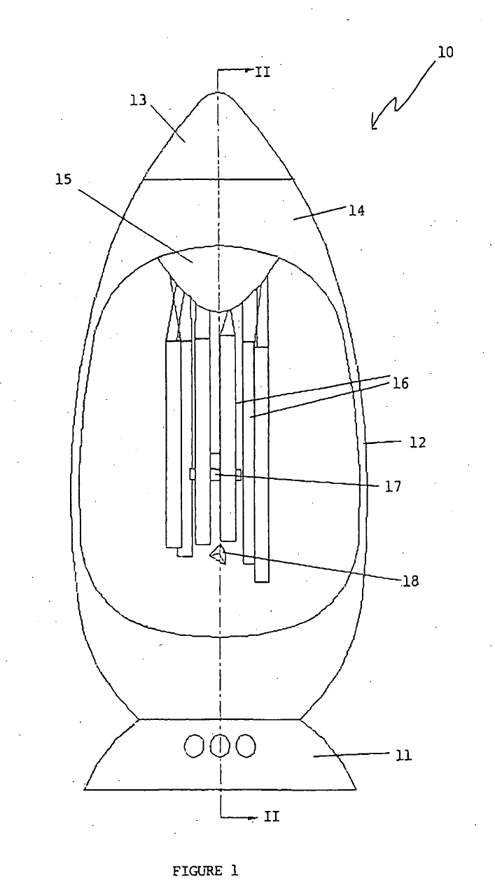

FIG. 2 is a schematic cross-sectional elevational view of the wind chime of FIG. 1 taken at II-II in FIG. 1.

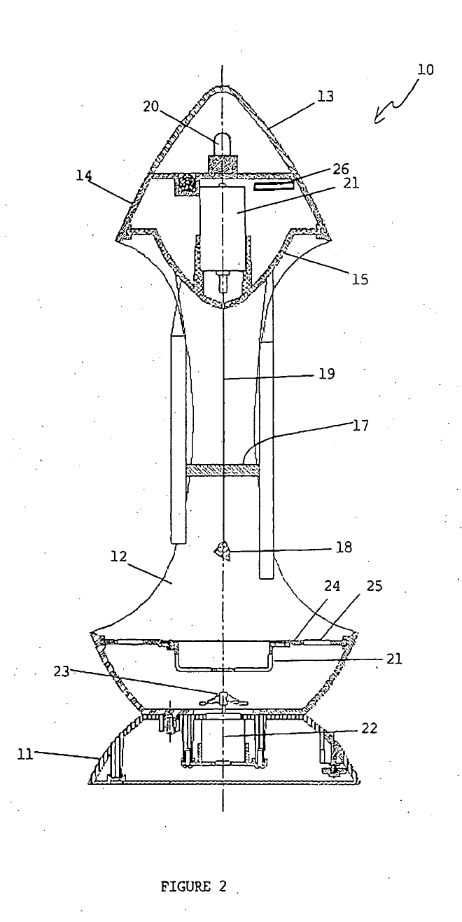

### DESCRIPTION OF THE PREFERRED EMBODIMENT

In the accompanying drawings there is schematically depicted a chime apparatus 10. Apparatus 10 comprises a base 11 supporting a frame 12, which in turn supports a rose 14. Positioned upon the rose 14 is a cap 13. Components 11, 12, 13 and 14 are typically fabricated from moulded plastics material. Typically, the base 11, frame 12 and rose 14 are formed integrally from opaque plastics material, whereas the cap 13 is typically of moulded light-transmissivie, coloured plastics material.

Formed integrally with the rose 14 is a nose 15 from which there depends a number of chime rods 16. Chime rods 16 are typically formed of metallic material such as aluminium, brass, stainless-sceel or copper. However, other materials including ceramic materials for example can be used. The rods can be hollow or solid and can be of differing length to thereby vibrate at different frequencies to produce sounds of different pitch when struck. Each rod can be attached to the nose 15 by a small cord or other means.

Mounted within the rose 14 and partially within the nose 15 is an electric motor 21. The output shaft of electric motor 21 has depending therefrom a cord 19 to which a striker or pendulum 17 is attached. The pendulum 17 preferably has corners and is typically of a triangular shape when viewed from above. Alternatively, the pendulum could be square or a polygon of more than four sides, or star-shaped for example. Attached to the same cord or another cord depending from the pendulum 17 is a decorative weight 18.

Situated within the cap 13 is a light bulb 20. The light bulb is mounted in a socket that is formed integrally with a top wall of the rose 14.

Within the base 11 is another electric motor 22 driving an impeller 23. Fitted within the top part of the base 11 is a plate 24 from which a basket 21 depends. The plate 24 has a number of apertures 25. Aromatic herbs (potpourri) can be placed into the basket. When the impeller 23 is activated by motor 22, air is drawn down through holes 25 and blown upwardly through the basket 21 to thereby diffuse aroma into the surrounding atmosphere. Alternatively, the impeller might operate in the reverse direction to draw air downwardly through the potpourri and then upwardly through the apertures 25. A grate can be provided above the basket 21 to contain the potpourri.

Upon activation of motor 21, the cord 19 rotates to thereby cause rotation of the pendulum 17. As the pendulum is typically of triangular shape when viewed from above, its corners strike the chime rods 16.

A passive wind chime provides a random sound effect, depending upon the prevailing wind strength, wind gusts and wind direction. To simulate this effect, circuitry can be associated with the motor 21 to vary its output speed, turn it on and off, reverse its output direction, leave the motor switched off for a while or otherwise randomly control its output. In the illustrated embodiment, a control circuit 26 can be provided in the rose 14 or other part of the apparatus for performing this control function.

A battery or batteries, or input socket for an external power supply (plug pack) can be provided in the base 11 or other part of the device. A switch might also be provided in the base or rose for example. Wires can extend from the base to the rose via the frame. A single switch might activate both motors and the light bulb, or separate switches might be provided. Furthermore, the circuitry associated with motor 21 might simultaneously activate motor 22 to thereby diffuse pleasant aroma only when the motor 21 causes chiming of the chime rods 16. This would further enhance a perception of simulation by spreading a pleasant aroma only at a time when the effect of wind is simulated by motor 21.

It should be appreciated that modifications and alterations obvious to those skilled in the art are not to be considered as beyond the scope of the present invention. For example, instead of suspending the chime rods 16 from a rose 14, the rods might be mounted from beneath by springs for example extending from the base. Likewise, instead of suspending the pendulum 17 from a cord which in turn depends from a motor in a rose, another motor might be provided in the base with an upwardly extending flexible wire extending from its upwardly-directed output shaft to which the pendulum 17 could be mounted.

1. A chime apparatus comprising:
a rose,
a plurality of chime rods attached to the rose,
a striker attached to the rose and positioned adjacent the chime rods, and
a motor, which upon activation causes movement of the striker to strike the chime rods.

2. The apparatus of claim 1, wherein the chime rods are suspended from the rose.

3. The apparatus of claim 1, wherein the striker is a pendulum suspended from the motor.

4. The apparatus of claim 3, wherein the pendulum is of a shape having comers.

5. The apparatus of claim 4, wherein the pendulum is triangular.

6. The apparatus of claim 5, further comprising a cord extending between an output shaft of the motor and the pendulum.

7. The apparatus of claim 6, further comprising a weight attached to the cord beneath the pendulum.

8. The apparatus of claim 7 further comprising a frame supporting the rose and a base that supports the frame.

9. The apparatus of claim 1, further comprising a basket for receiving at least one aromatic substance in or upon the base.

10. The apparatus of claim 9 further comprising a fan mounted in the base to diffuse aroma from the substance located in said basket.

11. The apparatus of claim 10 further including a cap upon the rose and within which is situated a light emitter.

12. The apparatus of claim 11, wherein the cap is light transmissive.

13. The apparatus of claim 12, wherein the cap is coloured.

14. The apparatus of claim 1 further including a control circuit operating the motor.

15. The apparatus of claim 14, wherein the control circuit provides periodic activation of the motor.

16. The apparatus of claim 14, wherein the control circuit reverses the motor.

17. The apparatus of claim 14 wherein the control circuit provides random operation of the motor.

18. The apparatus of claim 15, wherein the control circuit reverses the motor.

19. The apparatus of claim 17, wherein the control circuit reverses the motor.
